(19) United States
(12) Patent Application Publication
(10) Pub. No.: US 2023/0122416 A1
(43) Pub. Date: Apr. 20, 2023

(54) METHOD FOR CONTROLLING A DEVICE FOR THE EXTRACTION IN PARTICULAR OF A TOOTH ROOT, AND A DEVICE

(71) Applicant: Benno Syfrig, Luzern (CH)

(72) Inventor: Benno Syfrig, Luzern (CH)

(21) Appl. No.: 17/907,047

(22) PCT Filed: Feb. 25, 2021
(86) PCT No.: PCT/EP21/54716

§ 371 Date: Sep. 22, 2022

(30) Foreign Application Priority Data
Mar. 23, 2020 (CH) 00346/20

(51) Int. Cl. A61C 3/14; A61C 1/06

(52) U.S. Cl. CPC A61C 3/14; A61C 1/06

(57) ABSTRACT

In a method for controlling a device for the extraction in particular of a tooth root, the device has a front mouth-side support, a tensioning element guided in the latter, and a tensioning mechanism connectable to the tensioning element. The tensioning element is deflected, at the front, approximately at right angles to the longitudinal extent of the support and is connected to a pin fastenable in the tooth root. The tensioning element is drawn to its stretched state by a controllable motor with low expenditure of force or is connected in this stretched state to the pin. The tensile force is then increased manually or automatically to a predefined fixed or variable value by increasing output of the motor of the tensioning mechanism, and thereafter, when the tooth root has come loose, the motor output is reduced to a defined value or to zero.

### FIELD OF THE INVENTION

The invention relates to a method for controlling a device, for the extraction in particular of a tooth root and such a device, wherein the device includes a front mouth-side support, a pulling element guided in the support, and a pulling mechanism which can be connected to this, wherein the pulling element is deflected on the front side at approximately right angles to the longitudinal extension of the support, and can be connected to a pin or the like which can be secured to the tooth root.

### BACKGROUND OF THE INVENTION

With a known device for the extraction of a tooth root in accordance with the printed publication EP-A-1 578 296 (considered to correspond to U.S. Pat. No. 7,435,087), provision is made for a tensioning device which can be partially introduced into the mouth and supported in it in order to produce the pulling force necessary for drawing the root, which comprises an adjustable pulling element, which can be connected to the pin which can be secured in the tooth root. For this purpose, the tensioning device comprises a longitudinally extended basic body, and, longitudinally adjustable opposite this, a tensioning support which is functionally connected to the jointed pulling element, which is provided with a threaded bolt, this bolt passing through a support sleeve secured to the basic body and having a knurled nut screwed onto it, which comes in contact with the support sleeve.

With this device, and depending on the circumstances, an extraction of the tooth root can be carried out with relatively little effort, wherein the pin, secured in the tooth root and connected to the pulling element of the tensioning device, can be subjected to a pulling force by means of the tensioning device, which is partially introduced into the mouth and supported in it, by a manual rotation of the knurled nut, and the tooth root is then extracted with the pin. As a result, a reliable extraction of a tooth root can be achieved by manual actuation.

Taking this generic device as a starting point, the invention is based on the object of providing such a device, as well as a method for controlling it, by means of which this extraction of the tooth root is made possible in an at least partially automated manner, without the dentist being obliged, as a rule, to engage manually in the extraction procedure.

### OBJECTS AND SUMMARY OF THE INVENTION

This object is solved according to the invention by a method for controlling a device, for the extraction in particular of a tooth root and such a device, wherein the device includes a front mouth-side support, a pulling element guided in the support, and a pulling mechanism which can be connected to this. The pulling element is deflected on the front side at approximately right angles to the longitudinal extension of the support, and can be connected to a pin or the like which can be secured to the tooth root. According to invention, the pulling element can be provided with such a pulling force by means of a controllable motor, assigned to the pulling mechanism, in order that, in particular, a tooth root can be extracted.

A device comprises a front mouth-side support, a pulling element guided in this support, and a pulling mechanism which can be connected to it, wherein the pulling element is deflected at the front approximately at right angles to the longitudinal extension of the support, and can be connected to a pin or similar element which can be secured in the tooth root.

In the device, the pulling mechanism includes a controllable motor for producing a pulling force of the pulling element, which is contained in a housing with the front-side support, or in a separate device, and is actuated and controlled by a control device in such a way that, with this motor, such a pulling force can be exerted onto the pulling element that an extraction of a tooth root is possible without manual intervention.

Very advantageously, with the method for controlling this device, the pulling force at the pulling element is increased manually or automatically by increasing the preferably electrical output of the motor of the pulling mechanism to a predetermined fixed or variable value, and, following this, when the tooth root has been detached, the output of the motor is reduced to a specific value or to zero.

Accordingly, an extraction of a tooth root can be carried out by a person skilled in the art, in particular a dentist, with little manual intervention, very easily and extremely reliably. Such a surgical intervention is also extremely pleasant for a patient, and the entire procedure can take place with a better controlled sequence, without the risk of complications. A dentist can apply this controlling according to the invention of this device, and therefore the extraction, with a rapid learning curve.

Due to the automated adjustment of the electrical output of the motor of the pulling mechanism to the maximum pulling force, and, respectively, the reduction of this output when the tooth root has been detached, such an extraction can be carried out in an extremely simple manner, and the activity of the dentist can be restricted to monitoring the course of the procedure, with a sequence free of any disruption.

Very advantageously, a controllable electric rotary motor for the pulling mechanism is used as a motor, with which, by the detection of its speed of rotation per time unit, the adjustment path and adjustment speed of the pulling element can be determined.

In addition, with the device according to the invention, the pulling mechanism with the controllable motor is provided in a housing with the front-side support, and is actuated and controlled by a controlling device in such a way that this extraction of the tooth root can take place without manual intervention.

### BRIEF DESCRIPTION OF THE DRAWINGS

The invention and its further advantages are explained in greater detail hereinafter on the basis of exemplary embodiments and by making reference to the drawings. The figures show:

FIG. 1 is a longitudinal section of a device according to the invention,

FIG. 2 is a perspective side view of the device according to the invention in accordance with FIG. 1, wherein a rotary motor and a reduction gear are shown as separated from the support, in each case as one modular unit, and

FIG. 3 is a diagram of the course of the pulling force of the motor onto the pulling element, and the adjustment path of the pulling element, in each case as a dependency of the time.

### DETAILED DESCRIPTION OF THE INVENTION

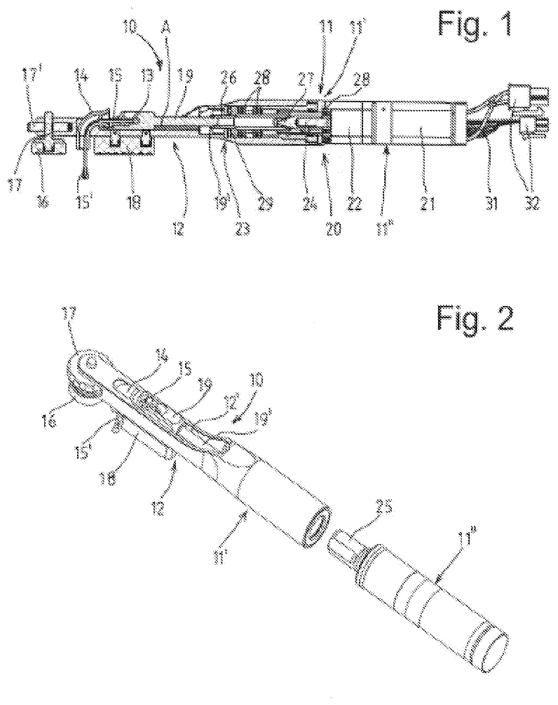

FIGS. 1 and 2 show a device 10 for extracting in particular a tooth root, not shown in any greater detail, which is used in particular in dental technology. With regard to the tooth roots, the tooth can be partially or wholly broken off or have been removed, and this may also relate to natural or artificial roots, or roots with an artificial part.

The device 10 comprises a multi-part housing 11 and a front support 12 connected to it, in each case with a longitudinal configuration. Guided longitudinally in the support 12 is a pulling element 15, and a carriage 19 connected to this, which is guided in a guide path 12′ of the support 12, essentially free of play, and which can be connected at the rear end to a pulling mechanism 20. The pulling element 15 is deflected on the front side about an angled guide element 14 at approximately right angles to the longitudinal extension of the support 12, and at its front end comprises a connecting element 15′, which can be connected to a pin or similar element secured in the tooth root, by being suspended into it, screwed in, or in some other manner.

On the front side, and behind the deflected pulling element 15, the support 12 is provided in each case with a support or bearing jaw 16, 18, of which at least one can be adjusted by means of an adjustment screw 17 with a nut 17′, likewise at right angles to the support 12, in order to adjust the alignment of the device 10 in the mouth of the patient in such a way that the direction of pull of the pulling element 15 effectively runs in the direction of the root, such that no interfering lateral friction forces occur during the extraction, if the direction of the pull were to deviate from the axial direction of the gap. The configuration and dimensioning of this front-side support 12 with the guide of the pulling element 15 can of course differ depending on the requirement.

According to the invention, the pulling mechanism 20 in the housing 11 is provided with a controllable motor 21 for producing a pulling force for the pulling element 15, which is actuated and controlled by a control device in such a way that, with this motor 21, such a pulling force can be exerted onto the pulling element 15 that an extraction of the tooth root is possible without manual intervention.

Very advantageously, this motor is configured as a rotary motor 21, which is arranged on the rear side in the housing 11, and from this connection cables 31 are provided, leading away to the rear, with connection plugs 32. Provided coaxially to this rotary motor 21 in the housing 11 is a reduction gear 22, rotationally connected to it by a drive shaft, and a conversion element 23 for converting the rotational movement into a linear movement for the adjustment of the carriage 19, and therefore of the pulling element 15 in the support.

The conversion element 23 is formed from a threaded sleeve 26, rotationally connected to a drive shaft 24 of the reduction gear 22, and a threaded spindle 19′ of the carriage 19. The drive shaft 24 can be connected via a coupling member 27 coaxially with the threaded sleeve 26, wherein the latter is supported in the housing at the circumference by slide bearings 28 and by at least one axial bearing 29, in such a way that it is ensured that the pulling forces produced by this, predominantly along the axis A during the extraction, will be reliably absorbed.

For the purpose of control, the rotary motor 21 is electrically connected by the connection cable 31 to a control device, not shown in greater detail. For this purpose, on the one hand connection cables 31 are provided for the power supply, and, on the other, for the control elements and for measuring elements of the rotary motor 21, as connection to the control device in an external device, by means of which the required control and measurement functions can be carried out in a program-controlled manner.

The rotational torque moment exerted on the rotor of the rotary motor 21 is effected preferably by way of the adjustable current strength of the motor. Accordingly, the pulling force F on the pulling element 15 is adjusted accordingly by means of the control device, and is automatically controlled during the extraction process. For this purpose, the rotary motor 21 is advantageously equipped with a rotation speed measuring device, not shown in greater detail. As a result, the present rotation speed can be detected by a signal transfer to the control device, and can be evaluated by it.

The rotary motor 21 can be, for example, a brushless DC motor with an ironless winding, with which a close to stepless change in the revolution speed is possible, such as is known from Maxon by way of the maxon EC motor type. Integrated in this rotary motor is such a revolution speed measuring device as functions in an inherently known manner by way of Hall sensors as measuring elements.

As the reduction gear 22, use can also be made of a device from Maxon, of the maxon gear type, which is configured as a planetary gear, element 22 can thus also refer to a planetary gear. These are therefore not explained in any greater detail. It is of course possible for other motors and gears to be used which are suitable for the functions required.

With the planetary gear, it is possible for the revolution speed of the motor to be reduced from, for example, between 100 to 1000 rev/min to a few revolutions per minute, and, with the conversion element 23, with a thread pitch of, for example, one millimetre, it is possible for a longitudinal adjustment of the carriage 19, and therefore of the pulling element 15, along the axis A, to be adjusted by a few millimetres per minute, as a result of which the extraction force can be optimally determined.

Both this rotary motor 21 and the planetary gear 22 are characterized in that, with an adequate output, they exhibit a small cylindrical outer diameter, such as 15 to 30 millimetres, such that the housing 11 can likewise be dimensioned with a cylindrical outer form, in the shape of a handle, with a diameter adapted to the ball of the hand. The outer casing of the housing 11 can be made of a roughened or suitable gripping material, in order to allow for a secure hold. In this situation it consists of several cylinders of the same diameter arranged next to one another, wherein the rotary motor 21 and the reduction gear 22 form a structural unit or module 11′, and the support 12 with the cylinder forms a structural unit or module 11′, which can be plugged into one another and fixed in a rotationally-resistant manner.

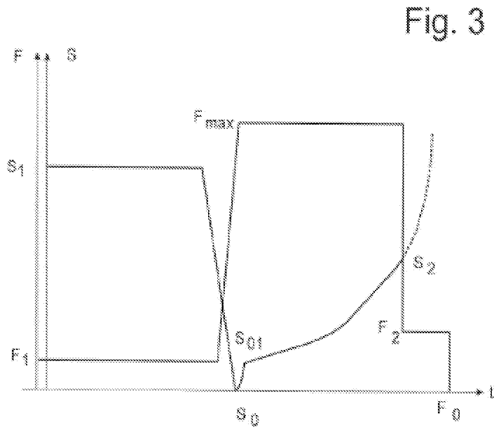

According to the diagram from FIG. 3, the method of control of the device 10 is shown at the time of extraction. In this situation, the abscissa represents the time t, and two ordinates represent the pulling force F taking effect by the pulling element 15 on the tooth root on the one hand, and, on the other, the movement path S per time unit of the pulling element 15 and of the tooth root respectively.

During the extraction process, as preparation in the conventional manner, this device 10 with the support 12 is placed in the mouth of a patient, and aligned in such a way that the tooth root which is to be extracted, with the pin screwed into it, lies in the pulling element 15, beneath or above the pulling element 15 pointing at right angles away from the support 12, and the connecting element 15′ of the latter is suspended or otherwise connected at the end of the pin.

As indicated heretofore, attention must be paid to ensuring that the pulling axis and the axis of the root, in which the tooth root is held by fibers, are aligned running approximately equally or coaxially to one another, in order to create optimum conditions for the most unimpeded possible extraction. This can be adjusted accordingly at the bearing by the nut 17′ mounted in it, and by the adjustment screw 17 and the bearing jaw 16, which interact with it.

When a dentist or specialist person has positioned the device 10 in the mouth correctly and securely, he can set the rotary motor 21 in motion by means of a switching element, for example by a pedal or a manual switch, and initiate the pulling, such that the pulling element 15 is moved in an automated manner, with an approximately constant small adjustment path per unit or movement speed S₁ and pulling force F₁ away from the tooth root along the axis A against the housing 11.

As soon as the pulling element 15 adopts the extended state, the movement speed drops, with the low pulling force F₁ taking effect, to a value S₀ which is close to zero, which, depending on the positioning of the device 10, can take place after a movement path of just a few millimetres. By measuring the revolution speed of the rotary motor 21, this lowering of its movement speed to close to zero is detected and notified to the control device by the transfer of a signal.

Next, the pulling force F is automatically increased, by increasing the electrical output of the rotary motor 21, to a predetermined fixed or changeable maximum value Fₘₐₓ. As a result, the full pulling force Fₘₐₓ is transferred onto the tooth root. As a rule, at the beginning of the increased pulling force _{Fmax}, the pulling element 15 is increased rapidly from the movement speed S₀ of zero to a derived value S₀₁, due to the fact that first the pulling element 15, then the conversion element 23 and the rotary motor 21 are extended or adjusted to full tension. Following this, the movement speed S₀₁, at the maximum pulling force Fₘₐₓ, will increase slightly, depending on the resistance of the tooth root, as represented in FIG. 3.

It is also possible to proceed in such a way that the pulling element 15 at first does not move, and it is only after a certain period of load imposition onto the fibers holding the tooth root in the jawbone that it moves. Provision can be made within the framework of the invention for the dentist to actuate the switching element during the pulling process, such that the rotary motor 21 automatically produces a changeable maximum value Fₘₐₓ, in order thereby to improve the detachment of the tooth root. This maximum value Fₘₐₓ can be reduced by automated means, for example, by a half, and then increased again to the full value, and this can take place several times as an oscillating force pattern. It can also happen that the tooth root is positioned in a wedge shape in the jawbone, and the dentist then attempts to detach it with an appropriate tool.

When the tooth root has been detached from the jawbone, or at least the resistance of the root has lessened, the output of the rotary motor 21, and therefore the pulling force Fₘₐₓ, is reduced to a specific value F₂ and then to the value F₀ as stop. This depends on how far the tooth root has been drawn out, and whether it is in any event underneath at the guide element 14. As soon as the tooth root has become detached, or the resistance by the root has reduced, this causes an increase in the movement speed S₂, at full pulling force. This is identified by the control device, and this is programmed in such a way that the motor output is reduced immediately.

The movement path of the pulling element 15 in the support 12 can, as an alternative, be determined by a referencing of its longitudinal position. The increase in the motor output before the extraction and/or its reduction after the detachment of the tooth root would be determined on the basis of the referenced longitudinal positions of the pulling element, and not by its movement speeds. The movement paths of the pulling element could be counted by the revolution speeds of the rotary motor 21, and controlled accordingly.

The changing of the motor output could also be carried out by a manual actuation of the switching element, wherein the extraction is initiated, interrupted, or stopped by means of the pulling mechanism.

The invention has been adequately described by the exemplary embodiment explained heretofore. It could, however, of course be explained by further variants.

In principle, the rotary motor, and, as appropriate, also the reduction gear, could be integrated in an external device, and a rotational movement and/or a linear movement could be connected to the pulling element by way of a transfer element in a flexible tube or the like, between the device and the housing. The reduction gear could, as described with the foregoing exemplary embodiment, likewise be contained in the housing, and it would then be coupled to a rotatable transfer element.

It would also be possible to provide a linear motor or a rotary motor, which interacts directly with the pulling element by way of a connection, such as a nut/threaded spindle. The pulling element could be configured as more than one longitudinal element, with preferably a parallel orientation, and in each case a wire cable or similar is used.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. Method for controlling a device for the extraction in particular of a tooth root, wherein the device comprises a front mouth-side support, a pulling element guided in the support, and a pulling mechanism connected to the pulling element, wherein the pulling element is deflected on the front side at approximately right angles to the longitudinal extension of the support, and connectable to a pin securable to the tooth root, wherein the pulling element is be provided with a controllable motor, assigned to the pulling mechanism, with such a pulling force that, as a result, the tooth root will be extracted.

2. Method according to claim 1, wherein the pulling element is pulled by the controllable motor with low force expenditure as far as its extended state, or, in this extended state, is connected to the pin, and then the pulling force is increased manually or automatically by increasing the output of the motor of the pulling mechanism to a predetermined fixed or changeable value, and, following this, when the tooth root has detached, the output of the motor is reduced to a predetermined value or to zero.

3. Method according to claim 1, wherein a determination is made of the movement path per time unit of the pulling element at a predetermined output of the motor, and, as soon as the movement path per time unit is at least almost stopped due to the increased resistance by the root, despite the unchanged motor output, the motor output is then increased, manually or automatically, to the predetermined fixed or changeable value.

4. Method according to claim 1, wherein, after the increase in the motor output, the movement path per time unit is determined, which initially was close to zero or very small, and, when the tooth root has detached, due to the drop in resistance by the root and the resultant speeding up of the movement path, the motor output is reduced in an automated manner to the predetermined value or to zero.

5. Method according to claim 1, wherein the movement path of the pulling element in the support is determined by referencing its longitudinal position, and the increase in this before the extraction and/or reduction, after the detachment of the tooth root, is determined on the basis of the determined longitudinal positions of the pulling element in the support.

6. Method according to claim 1, wherein a controllable electric rotary motor is used as the motor for the pulling mechanism, wherein, by a determination of its number of rotations per unit, the movement path or the movement speed respectively of the pulling element respectively is determined.

7. Method according to claim 6, wherein the movement path of the pulling element in the support is determined by the rotation speed of the rotor of the rotary motor, with referencing of several positions of the pulling element in the support.

8. Method according to claim 1, wherein as soon as the tooth root has become detached, or the resistance of the tooth root has decreased, this has the effect, at full pulling force, of causing an increase in the movement speed of the pulling element, which is identified by the control device, and the motor output is then immediately reduced.

9. Method according to claim 1, wherein the change in the motor output is implemented by manual actuation, wherein the extraction is initiated, interrupted, or stopped by means of the pulling mechanism.

10. Device for carrying out the method according to claim 1, wherein the pulling mechanism comprises a controllable motor for producing a pulling force of the pulling element, which is contained in a housing with the front-side support, or in a separate device, and is actuated and controlled by a control device in such a way that, with this motor, such a pulling force is exerted onto the pulling element that an extraction of a tooth root is possible without manual intervention.

11. Device according to claim 10, wherein the pulling mechanism comprises a rotary motor as a controllable motor, a reduction gear rotationally connected to the motor, and a conversion element for converting the rotational movement into a linear movement for the adjustment movement of the pulling element.

12. Device according to claim 10, wherein the housing is configured with the outer shape of a handle for holding the device in the extraction position, and the pulling mechanism is contained in this.

13. Device according to claim 10, wherein the rotary motor is equipped on the front side with a drive shaft and on the rear side with an electrical connection cable with supply and control lines, connecting to an external device, wherein this drive shaft of the rotary motor is rotationally connected to the reduction gear, and these are arranged coaxially together with the conversion element for converting the rotational movement into a linear movement.

14. Device according to claim 10, wherein the rotary motor is configured as a brushless DC motor, the reduction gear in configured as a planetary gear, and/or the conversion element is configured as a threaded spindle/nut combination.
